(19) United States
(12) Patent Application Publication
(10) Pub. No.: US 2025/0053025 A1
(43) Pub. Date: Feb. 13, 2025

(54) OPTICAL LENS ELEMENT FOR SLOWING DOWN EVOLUTION OF ABNORMAL VISUAL REFRACTION

(71) Applicant: Essilor International, Charenton-Le-Pont (FR)

(72) Inventors: Eric GACOIN, Paris (FR); Matthieu GUILLOT, Issy Les Moulineaux (FR); Bruno FERMIGIER, Maisons Alfort (FR); Aude BOUCHIER, Toulouse (FR)

(73) Assignee: Essilor International, Charenton-Le-Pont (FR)

(21) Appl. No.: 18/718,553

(22) PCT Filed: Dec. 16, 2022
(86) PCT No.: PCT/EP2022/086380

§ 371 Date: Jun. 11, 2024

(30) Foreign Application Priority Data
Dec. 17, 2021 (EP) 21306843.0

(51) Int. Cl. G02C 7/02

(52) U.S. Cl. CPC G02C 7/022; G02C 2202/20; G02C 2202/24

(57) ABSTRACT

A lens element intended to be worn in front of an eye of a wearer, the lens element being adapted to provide a prescribed dioptric correction function in a prescription plane, the lens element including an arrangement of microoptical elements. When receiving a collimated beam of monochromatic light, the lens element is configured to produce a primary luminous intensity maximum in a prescription plane, and the arrangement of microoptical elements is configured to produce at least one first secondary luminous intensity maximum at a first proximity difference from the prescription plane and at least one second secondary luminous intensity maximum at a second proximity difference from the prescription plane, the first proximity difference and the second proximity difference having opposite signs.

### TECHNICAL FIELD OF THE INVENTION

The disclosure relates to the field of optical lenses for correcting abnormal refraction of the eye.

More precisely, the invention relates to a lens element intended to be worn in front of an eye of a wearer. The lens element is adapted to provide a given dioptric correction function in a prescription plane.

The invention also relates to a method for manufacturing the lens element according to the invention.

### BACKGROUND INFORMATION AND PRIOR ART

Some visual defects, such as myopia, or hyperopia, evolve with time.

Myopia of an eye is characterized by the fact that the eye focuses light in front of the retina. In other words, a myopic eye presents a length that is not suitable for clear vision. Myopia has both genetic and environmental origins. In the latter case, it develops due for instance to the increase in near vision tasks and in usage of digital devices such as digital screens of computers and smartphones, but also to less outdoor activities.

Many solutions exist that aim at reducing myopia evolution. For instance, progressive or bifocal lenses are used to reduce the accommodative lag observed in myopic children. Color filters are used to reduce or cut red light focusing behind the retina. Lens presenting a higher power in their periphery are used to compensate for the peripheral defocus phenomenon.

Recently, solutions consisting of inducing blur on the periphery of the retina have emerged. Experiments demonstrated that a contrast reduction in the periphery of the retina has significant effects on the physiology of the eye and especially on mechanisms responsible for the growth of the eye, and, as a consequence, on the eye's length. The international patent application WO2020/138127 discloses a spectacle lens comprising a contrast adjustment unit including a dot portion group. The European application EP 3 746 001 A1 presents eyeglasses and contact lenses treated by applying a pattern of scattering centers with an aperture free of dots on the viewing axis.

### SUMMARY OF THE INVENTION

In this context, one object of the invention is to provide a solution able to produce blur on the periphery of the retina in a controlled manner.

The above object is achieved according to the invention by a lens element intended to be worn in front of an eye of a wearer, the lens element being adapted to provide a prescribed dioptric correction function in a predetermined plane, the lens element comprising an arrangement of microoptical elements, wherein, when receiving a collimated beam of monochromatic light:
the lens element is configured to produce a primary luminous intensity maximum in a predetermined plane,
the arrangement of microoptical elements covering a whole surface of the lens element or at least a part of the surface of the lens element, the arrangement of microoptical elements is configured to produce at least one first secondary luminous intensity maximum at a first proximity difference from the predetermined plane and at least one second secondary luminous intensity maximum at a second proximity difference from the predetermined plane, the first proximity difference and the second proximity difference having opposite signs, the microoptical elements comprise holographic micromirrors, wherein a first subset of the holographic micromirrors has a first mean optical power configured to produce the at least one first secondary luminous intensity maximum, and wherein a second subset of the holographic micromirrors has a second mean optical power configured to produce the at least one second secondary luminous intensity maximum.

For example, the microoptical elements have a size each of less than 2 mm.

For example, the lens element comprises a front face and a rear face adapted to provide the prescribed dioptric correction function.

In some embodiments, the arrangement of microoptical elements comprises a structured array selected among a squared array, a hexagonal array, or a combined octagonal squared array.

In some embodiments, the arrangement of microoptical elements comprises a random spatial arrangement.

In some embodiments, the microoptical elements further comprise spatially alternated refractive microlenses, wherein a first subset of the refractive microlenses has a first mean refractive power configured to produce the at least one first secondary luminous intensity maximum, and
wherein a second subset of the refractive microlenses has a second mean refractive power configured to produce the at least one second secondary luminous intensity maximum.

In some embodiments, the microoptical elements further comprise at least one bifocal refractive microlens presenting a first refractive power configured to produce the at least one first secondary luminous intensity maximum, and a second refractive power configured to produce the at least one second secondary luminous intensity maximum.

In some embodiments, the microoptical elements further comprise bifocal refractive microlenses, wherein a first subgroup of the bifocal refractive microlenses presents a predetermined refractive power configured to produce the primary luminous intensity maximum and a refractive power configured to produce the at least one first secondary luminous intensity maximum, and wherein a second subgroup of the bifocal refractive microlenses presents the predetermined refractive power and another refractive power configured to produce the at least one second secondary luminous intensity maximum.

In some embodiments, the microoptical elements further comprise diffractive optical elements presenting at least a first diffraction order for said monochromatic light configured to produce the at least one first secondary luminous intensity maximum, and a second diffraction order for said monochromatic light configured to produce the at least one second secondary luminous intensity maximum.

In some embodiments, the microoptical elements further comprise diffractive optical elements, wherein a first subset of the diffractive optical elements presents at least a predetermined diffraction order for said monochromatic light configured to produce the primary luminous intensity maximum and a diffraction order for said monochromatic light configured to produce the at least one first secondary luminous intensity maximum, and/or
wherein a second subset of diffractive optical elements presents at least the predetermined diffraction order and another diffraction order for said monochromatic light configured to produce the at least one second secondary luminous intensity maximum.

In some embodiments, the diffractive optical elements comprise Fresnel microlenses or multi-level microlenses.

In some embodiments, the microoptical elements are located on one of the two faces or between the two faces.

In some embodiments, the first proximity difference and the second proximity difference are higher than 0.5 diopter in absolute value.

Another aspect of the invention pertains to a method for manufacturing a lens element according to the invention, wherein the microoptical elements are formed by photolithography, holography, molding, machining or encapsulation.

### DETAILED DESCRIPTION OF THE INVENTION

In the description which follows the drawing figures are not necessarily to scale and certain features may be generalized or schematic form in the interest of clarity and conciseness or for informational purposes. In addition, although making and using various embodiments are discussed in detail below, it should be appreciated that as described herein are provided many inventive concepts that may be embodied in a wide variety of contexts. Embodiments discussed herein are merely representative and to not limit the scope of the invention. It will also be obvious to one skilled in the art that all the technical features that are defined relative to a process can be transposed individually or in combination, to a device, and conversely, all the technical features relative to a device can be transposed, individually or in combination, to a process.

For a more complete understanding of the description provided herein and the advantages thereof, reference is made now to the brief descriptions below, taken in connection with the accompanying drawings and detailed description, wherein like reference numerals represent like parts.

On joint drawings:

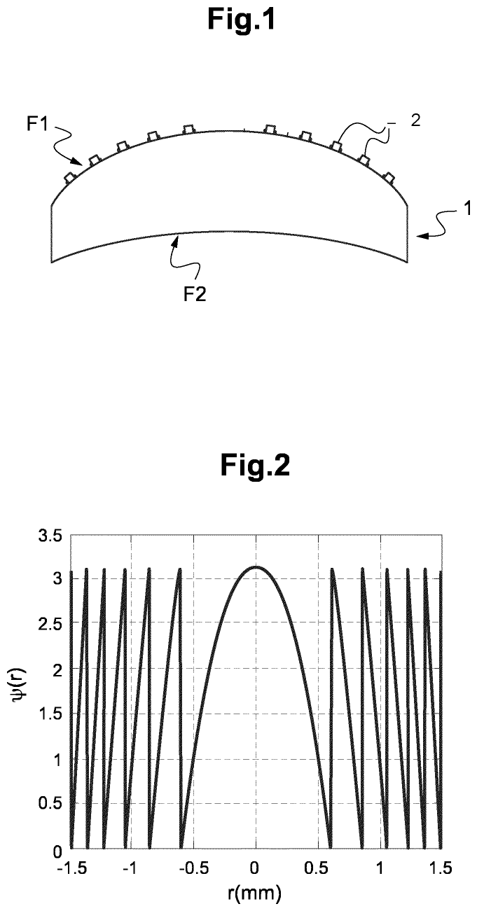

FIG. 1 is a schematic representation in cut view of the lens element according to an example of the invention;

FIG. 2 is an example of the phase profile of a Pi-Fresnel lens;

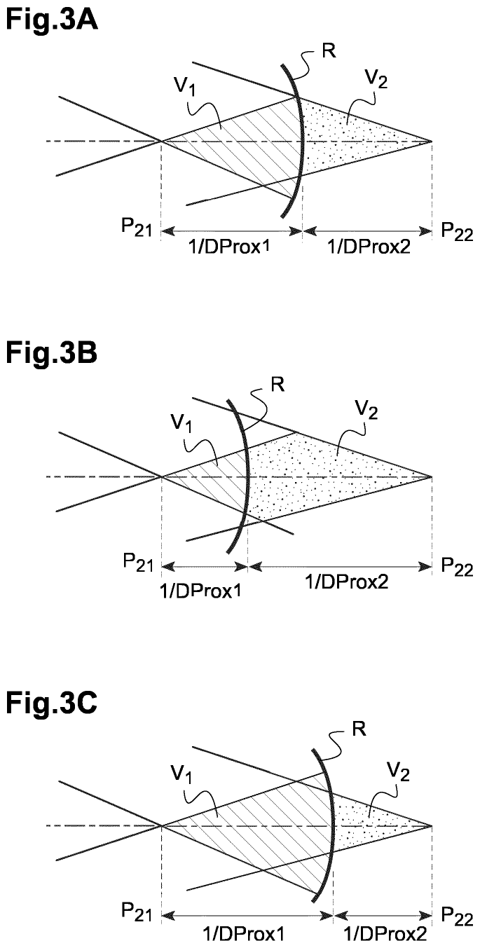

FIGS. 3A, 3B and 3C are schematic representations of a volume of light created by different arrangements of microoptical elements according to various exemplary embodiments/applications of the invention;

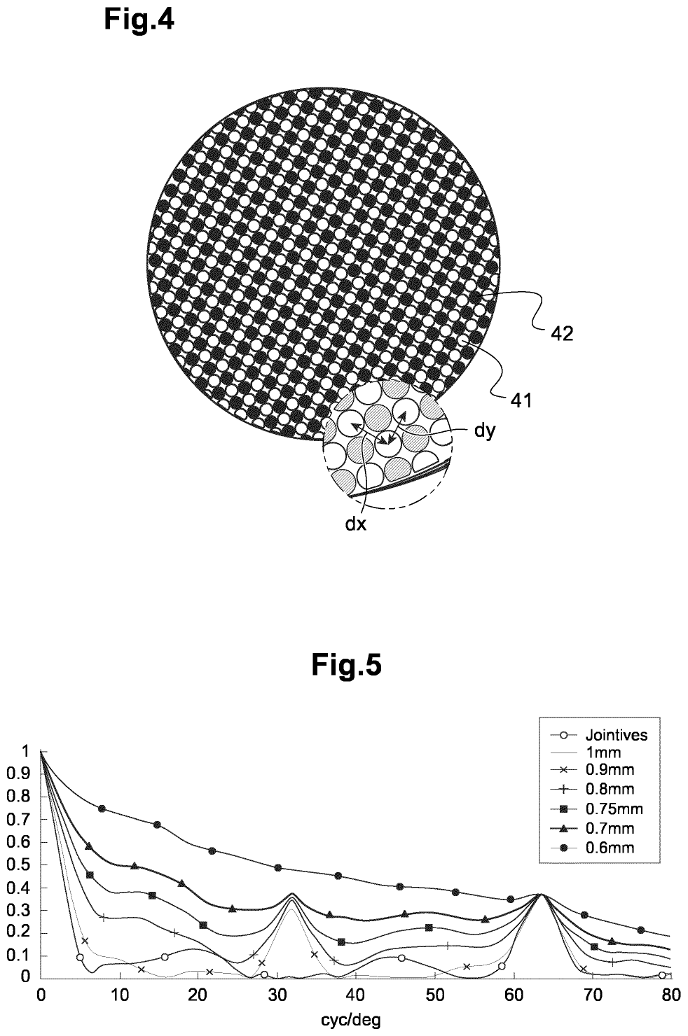

FIG. 4 illustrates a top view of an arrangement of microoptical elements according to a first embodiment of the invention;

FIG. 5 shows a comparison of the modulation transfer functions of different arrangements of microoptical elements according to the first embodiment of the invention;

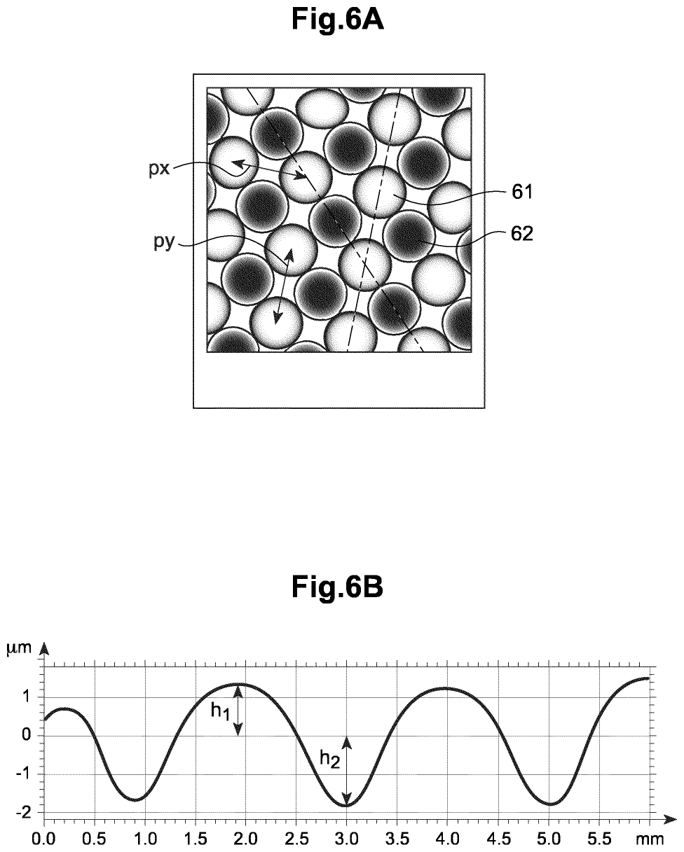

FIG. 6B illustrates a height profile across a line of microoptical elements in an arrangement shown in top view on FIG. 6A according to the first embodiment of the invention;

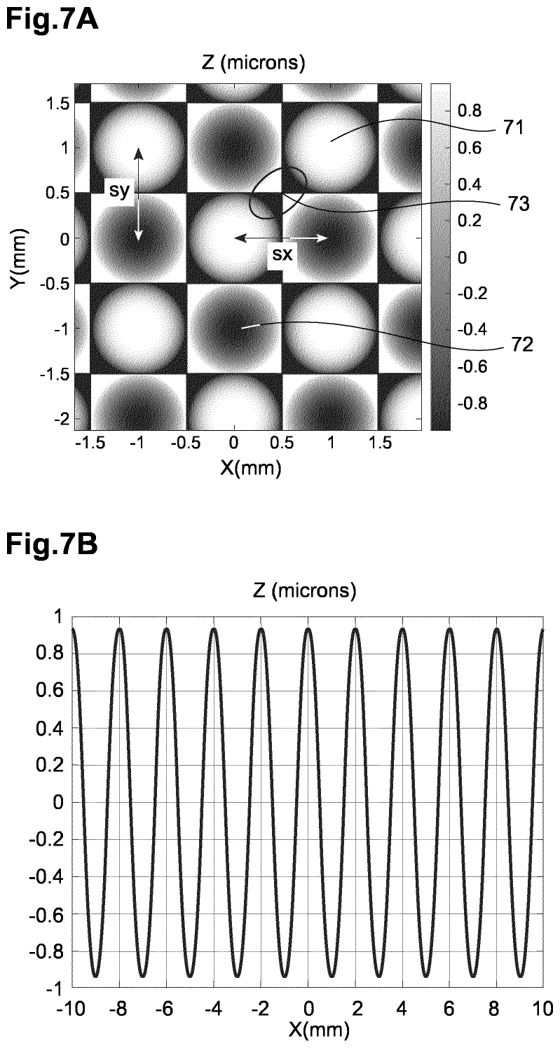

FIG. 7B illustrates a height profile across a line of microoptical elements in an arrangement shown in top view of FIG. 7A according to the first embodiment of the invention;

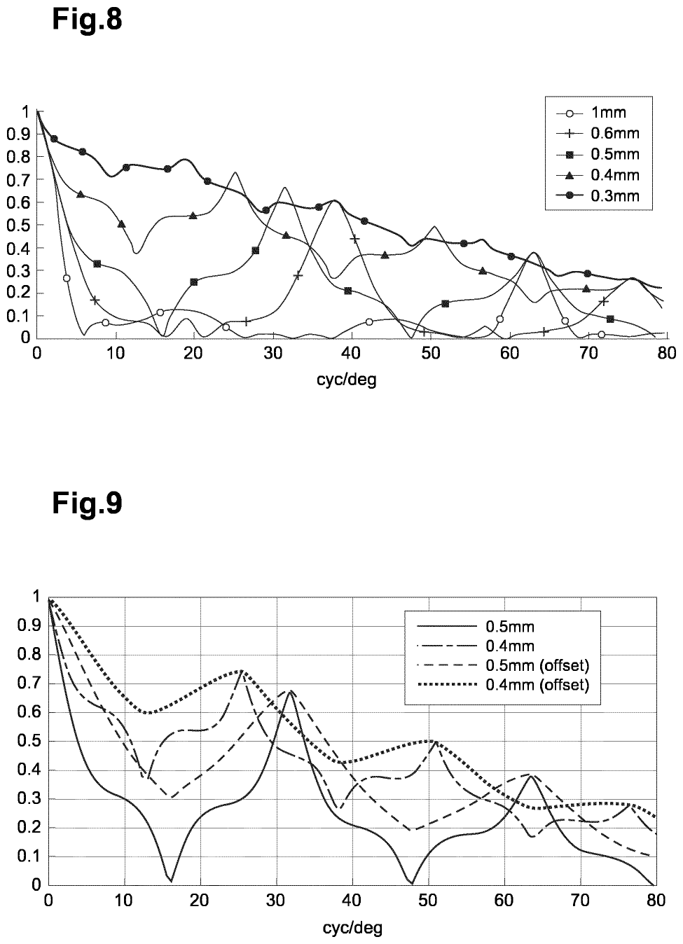

FIG. 8 shows a comparison of the modulation transfer functions of different arrangements of microoptical elements according to variants of the first embodiment of the invention;

FIG. 9 shows a comparison of the modulation transfer functions of improved versions of the different arrangements of microoptical elements of FIG. 7;

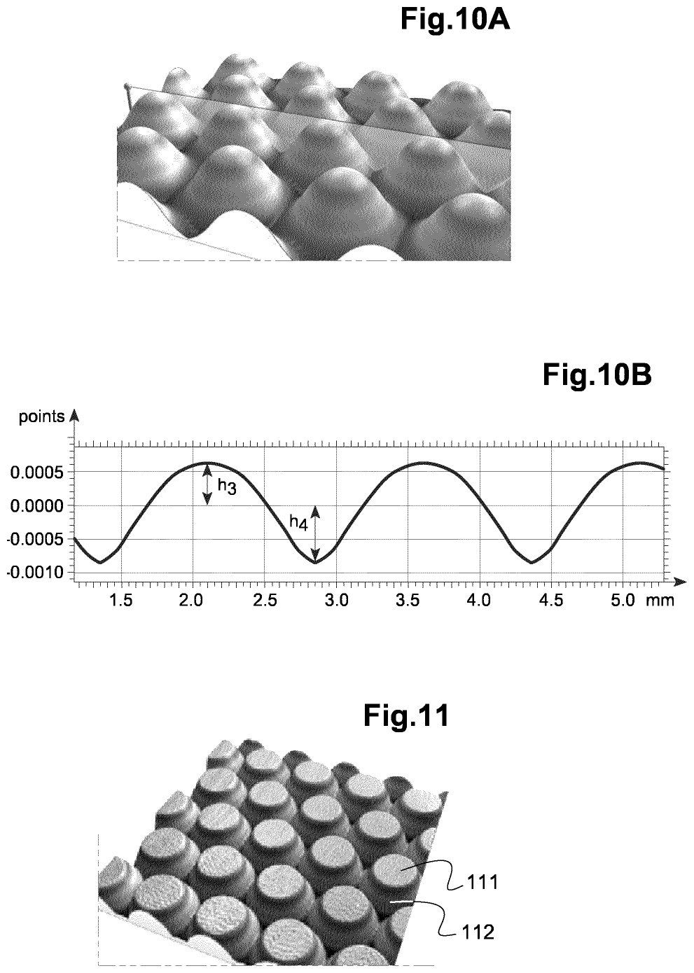

FIG. 10B illustrates a height profile across a line of microoptical elements in an arrangement shown in perspective view on FIG. 10A according to the first embodiment of the invention;

FIG. 11 shows an example of geometry of bifocal refractive microlenses shown in perspective view;

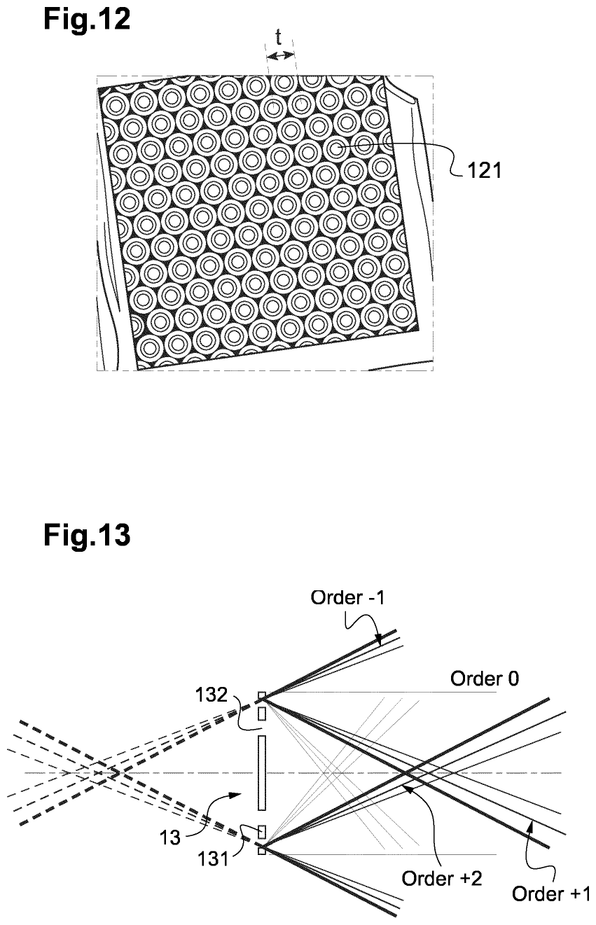

FIG. 12 shows an arrangement of microoptical elements shown in top view according to a fifth embodiment of the invention;

FIG. 13 shows diffraction orders of a binary diffractive optical element shown in cut view along an optical axis;

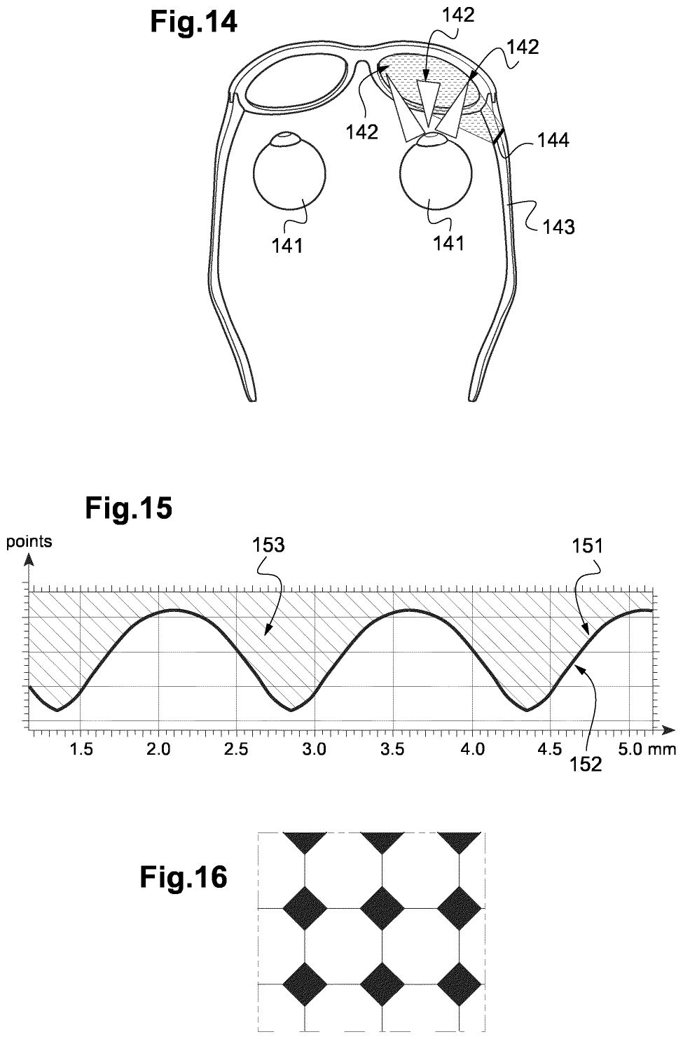

FIG. 14 illustrates eyeglasses including a lens element according to a sixth embodiment of the invention;

FIG. 15 illustrates a manufacturing variant of an alternation of positive and negative refractive microlenses;

FIG. 16 illustrates a combined octagonal squared array shown in top view.

The present invention proposes a solution to induce blur on the periphery of the retina of an individual by means of microoptical elements.

The microelements that are presented in this disclosure have a specific optical function, so that a set of them creates light scattering or defocus in front and behind the retina simultaneously. The light signal seen through the pupil of the individual is a combination of multiple signals (each signal being a defocus or a volume of non focused light) that exists on each side of the retina.

The microoptical elements create a kind of “diffusion” of light, or light scattering, or multiple defocus locations versus the retina, as a wanted effect, in order to reduce the contrast perceived by the individual, this reduction of contrast being, as explained above hypothetically slowing down myopia progression.

Thus, microoptical elements creating a scattered signal have a similar efficiency as diffusion provided by traditional ruguous elements, while being more aesthetical than those ruguous elements.

By microoptical element, it is meant an element that is able to alter the propagation or properties of incoming light by means of refraction, reflection, diffraction or polarization properties. Several elements can create diffraction together, but a single diffractive element too. It will be described in what follows how such microoptical elements can produce blur in the periphery of the retina in a controlled manner. For instance, the size of the microoptical elements is comprised between 0.1 and 3 mm, preferably between 0.5 and 2 mm. By size, it is meant either the diameter, or the length of an edge or the length of the diagonal of the microoptical element.

By controlled manner, it is meant that the design of the microoptical elements, that is, for instance, the shape, the dimensions and/or the spatial arrangement of the microoptical elements, is adapted to produce a predetermined amount of blur on the retina. The term “blur” designates the loss of details in the image of an object seen by the individual. Blur can be assessed by the loss in visual acuity it induces, or by an equivalent spherical defocus value in diopters. Blur induces a loss of contrast in the image of an object seen by the individual. This is why one goal of the invention is to induce blur to slow down myopia progression.

A way to assess the induced blur is to compute or measure the modulation transfer function of the lens element according to the invention. The modulation transfer function of an optical system quantifies the loss of contrast of a sine wave target seen without the optical system with respect to the contrast of the same sine wave target seen through the optical system.

More precisely, one aspect of the invention pertains to a lens element 1 intended to be worn in front of an eye of a wearer. The lens element 1 is adapted to provide a prescribed dioptric correction function Rx in a prescription plane P and comprises an arrangement of microoptical elements 2.

In the context of the present invention, the term “lens element” can refer to an uncut optical lens, or a spectacle lens edged to fit a specific spectacle frame.

As illustrated in FIG. 1, the lens element 1 comprises a front face F1 directed towards an object side, and a rear face F2 closer to the eye of the wearer in comparison to the rear face.

The prescribed dioptric correction function Rx is based on a prescription of the wearer in standard wearing conditions.

The term “prescription” is to be understood to mean a set of characteristics of optical power, of astigmatism, of prismatic deviation, determined by an eyecare practitioner in order to correct the vision defects of the wearer. For example, the prescription for an ametropic wearer may comprise the values of optical power and of astigmatism with an axis for the distance vision.

The prescribed dioptric correction function Rx may be provided by the front face F1 and the rear face F2. More precisely, the shapes of the front face F1 and the rear face F2 may be designed to provide the prescribed dioptric function Rx.

Alternatively, the prescribed dioptric correction function Rx may be provided by the arrangement of microoptical elements 2.

In a variant, the prescribed dioptric correction function Rx may be provided by both the face F1 and the rear face F2 and the arrangement of microoptical elements 2.

In another variant, the prescribed dioptric correction function is null, i.e. the lens element includes a plano lens providing a null refraction power at least for a determined vision distance or proximity.

The wearing conditions are to be understood as the position of the lens element 1 with respect to the eye of the wearer, for instance defined by a pantoscopic angle, a cornea to lens distance, a pupil to cornea distance, an eye rotation center (ERC) to pupil distance and a wrap angle.

The pantoscopic angle is the angle in the vertical plane between the normal to the rear surface of the lens element 1 and the visual axis of the eye in the primary position (usually considered to be the horizontal direction, when the wearer gazes straight ahead).

The cornea to lens distance is the distance along the visual axis of the eye in the primary position between the cornea and the back surface of the lens element 1.

The pupil to cornea distance is the distance along the visual axis of the eye between its pupil and its cornea.

The ERC to pupil distance is the distance along the visual axis of the eye between its ERC and its pupil.

The wrap angle is the angle in the horizontal plane between the normal to the rear surface of the lens element 1 and the visual axis of the eye in the primary position.

An example of standard wearing conditions may be defined by a pantoscopic angle of −8 deg., a cornea to lens distance of 12 mm, a pupil to cornea distance of 2 mm, an ERC to pupil distance of 11.5 mm and a wrap angle of 0°.

The microoptical elements 2 may be located on one among the front face F1 and the rear surface F2 of the lens element 1. In this case, the microoptical elements 2 may be formed for instance by surfacing, photolithography, molding, machining, holography, additive manufacturing, ink-jet, nano-imprint, nano 3D printing, direct laser writing, gradient of index, film lamination, or embossing. In a variant, a coating is applied on the surface of the microoptical elements 2.

Alternatively, the microoptical elements 2 are located between the front face F1 and the rear face F2. In this case, the lens element 1 may be fabricated by encapsulating the microoptical elements 2 (for example the microoptical elements 2 can be overmolded, film laminated, or coating covered). In a variant, modulations of refractive index between the front face F1 and the rear face F2 may be introduced.

The arrangement of microoptical elements 2 may be a structured array included on one among the front face F1 and the rear face F2 of the lens element 1, or between the front face F1 and the rear face F2. The structured array covers at least part or the whole surface of the front face F1, or of the rear face F2, or of an internal surface located between the front F1 and the rear face F2. By structured array, it is meant a regular periodic array.

For instance, the structured array is a squared array (like on FIG. 4), or a hexagonal array (like on FIG. 12), or a combined octagonal squared array (like on FIG. 16).

Alternatively, the arrangement of microoptical elements 2 comprises a random spatial arrangement. In other words, the microoptical elements 2 are not regularly positioned.

The microoptical elements 2 may be contiguous. By contiguous, it is meant that two neighbouring microoptical elements touch each other along a boundary or at a point. In other words, the arrangement of microoptical elements 2 presents a fill ratio of 100% By fill ratio, its is meant the ratio of the part of the surface of the lens element 1 covered by the arrangement of microoptical elements 2 compared to this part of the surface of the lens element 1 without the arrangement of microoptical elements 2. For instance, a fill ratio of 100% corresponds to the case where there is no free space between two microoptical elements 2.

The micro optical elements 2 may not be contiguous. For instance, the arrangement of microoptical elements 2 may present a fill ratio of 50%.

The microoptical elements 2 may cover the whole surface of the lens element 1. Alternatively, the microoptical elements 2 may cover only a part of the surface of lens element 1. For instance, a central part of the lens element 1 may have no microoptical element 2 or/and a peripheral part may have no microoptical element 2. The microoptical elements 2 may be of several types.

For instance, the microoptical elements 2 comprise unifocal components, such as refractive microlenses. By refractive microlens, it is meant spherical microlenses or aspherical microlenses. For instance, the size of the refractive microlenses may be comprised between 0.01 and 2.5 mm, preferably between 0.1 and 2.5 mm, more preferably between 0.3 and 1 mm. The optical power of the refractive microlenses may be comprised between 0.5 and 2000 diopters, preferably 0.5 and 20 diopters in absolute value.

For instance, the microoptical elements 2 comprise multifocal components, such as bifocal refractive microlenses.

For instance, the microoptical elements 2 comprise diffractive optical elements such as Fresnel micro lenses or multi-level diffractive optical microlenses. Fresnel microlenses may be of classical type, meaning that their phase function has 2π phase jumps at a nominal wavelength λ₀. Fresnel microlenses may be of the so-called type Pi-Fresnel, with a phase function presenting π phase jumps at a nominal wavelength λ₀. FIG. 2 illustrates the phase profile Ψ(r) of a Pi-Fresnel microlens as a function of the radius r of the Pi-Fresnel microlens. The phase profile presents a rotational symmetric about the central axis (r=0). In this example, the Pi-Fresnel microlens has a diameter of 3 mm and presents five annular rings of Pi-phase shift around a central area. Multi-level microlenses are components whose surface profile consists of several discrete surface heights. An example of multi-level diffractive optical microlenses is binary diffractive optical microlenses, presenting a two-level surface height.

For instance, the microoptical elements 2 comprise holographic micromirrors. Holographic micromirrors are micromirrors obtained by recording an interference pattern on a holographic plate. A holographic plate may consist of a transparent substrate (made out of glass or polymer) where a photosensitive material layer has been deposited. The recorded interference pattern confers, in the case of micromirrors, a reflective function to the holographic plate induced by local changes in refractive index in the photosensitive material layer. The recording of the interference pattern is performed with monochromatic light.

Advantageously, the transverse size of the microoptical elements 2 is equal to or smaller than 2 mm. By transverse size, it is meant for instance the diameter of the microoptical elements 2, or the dimension of one side or of the diagonal of one microoptical element 2.

When receiving a collimated beam of monochromatic light at a nominal wavelength λ₀, the lens element 1 produces a primary luminous intensity maximum I₁ in a prescription plane P. Typically, λ₀ is considered to be 550 nm for human eye vision applications. The prescription plane P is perpendicular to the optical axis of the lens element 1. The optical axis of the lens element 1 is defined as a straight line, perpendicular to the front face F1 and the rear face F2 of the lens element 1, along which light can pass undeviated, according to the definition of the ISO 13666 standard. Typically, the size of the collimated beam of monochromatic light at a nominal wavelength λ₀ is of the order of three times the transverse size of one microoptical element 2. For instance, the transverse size (or diameter if the collimated beam has a circular section) of the collimated beam is usually in the range between 4 and 8 mm, for example of 6 mm.

The primary luminous intensity maximum I₁ is created by the prescribed dioptric correction function Rx provided by the lens element 1. When the lens element 1 is worn by a wearer, the prescription plane P corresponds to a plane containing the foveal part of the retina of the wearer. The primary luminous intensity maximum I₁ is produced either by both the front face F1 and the rear face F2 of the lens element 1, through for instance their shapes, or by the arrangement of microoptical elements 2. Alternately, the primary luminous intensity maximum I₁ is produced by both the front face F1 and the rear face F2 and the arrangement of microoptical elements 2.

If the lens element 1 receives the collimated beam of monochromatic light at the nominal wavelength λ₀, then the arrangement of micro-optical elements 2 produces at least one first secondary luminous intensity maximum I₂₁ at a first proximity difference DProx1 from the prescription plane P and at least one second secondary luminous intensity maximum I₂₂ at a second proximity difference DProx2 from the prescription plane P. The first proximity difference DProx1 and the second proximity difference DProx2 have opposite signs. This means that the at least one first secondary luminous intensity maximum I₂₁ and the at least one second secondary luminous intensity maximum I₂₂ are positioned on either side of the prescription plane P.

The term proximity designates the inverse of a distance of a point to an apex sphere related to the lens element 1. The apex sphere is a sphere of center the eye rotation center of the wearer and of radius the distance between the eye rotation center of the wearer and the apex of the rear face F2 of the lens element 1. As examples, a value of radius of 25.5 mm for the apex sphere corresponds to a usual value and provides satisfying results when wearing the lenses.

Therefore, the first proximity difference DProx1 is the difference between the proximity of the point P₂₁ where the first secondary luminous intensity maximum I₂₁ is located and the proximity of the prescription plane P. The second proximity difference DProx2 is the difference between the proximity of the point P₂₂ where the second secondary luminous intensity maximum I₂₂ is located and the proximity of the prescription plane P.

When the lens element 1 is worn by the wearer, the at least one first secondary luminous intensity maximum I₂₁ and the at least one second secondary luminous intensity maximum I₂₂ define a volume of light V encompassing at least a portion of the retina and extending both in front and behind the retina. This volume of light V creates an extended and non concentrated spot of light on the retina. The extended and non concentrated spot of light induces a decrease in the contrast of objects seen by the wearer through the lens element 1 while maintaining good vision due to the primary luminous intensity maximum I₁. In other words, the lens element provides simultaneously a good vision due to the amount of light focused on the retina and a surrounding blur effect.

For instance, the first proximity difference DProx1 and the second proximity difference DProx2 are higher than 0.5 diopter in absolute value. The higher the absolute value of the first proximity difference DProx1 and the second proximity difference DProx2, the higher the amount of blur introduced and the higher the myopia development slowering effect. DProx1 and DProx2 are quantities equivalent to optical powers, as will be illustrated below.

In case the prescribed dioptric function Rx is null, in other words, the wearer does not need any dioptric correction, the prescription plane is located at infinity and the proximity of the prescription plane P is null.

The shape of the volume of light V is designed through the choice of the shape and other optical parameters of the microoptical elements 2 as well as the geometry of their spatial arrangement.

FIGS. 3a, 3b and 3c show schematically the geometry of the volume of light V, composed of a first sub-volume V₁, hatched, and of a second sub-volume V₂, represented with dots, for different positions of the point P₂₁ and of the point P₂₂. In FIG. 3a, the volume of light V is balanced between the front side and the rear side of the retina R, in other words, the first sub-volume V₁ and the second sub-volume V₂ are substantially equal. In FIG. 3b, the part on the rear side, that is, the second sub-volume V₂ of the retina R is predominant. In FIG. 3c, the part on the front side of the retina, that is, the first sub-volume V₁, is predominant.

In what follows, several embodiments of the lens element 1 will be described. Those embodiments may be combined.

In a first embodiment, at least part of the microoptical elements 2 are refractive microlenses. A first subset of the refractive microlenses has a first mean refractive power Pᵣ₁ configured to produce the at least one first secondary luminous intensity maximum I₂₁. A second subset of the refractive microlenses has a second mean refractive power Pᵣ₂ configured to produce the at least one second secondary luminous intensity maximum I₂₂. By “first mean refractive power” and “second mean refractive power”, it is meant the mean optical power created by one refractive microlens among respectively the first subset of the refractive microlenses and the second subset of the refractive microlenses.

In a first example, the refractive microlenses are spaced apart and non-contiguous to allow for a portion of the lens element 1 not covered by the microoptical elements 2 to produce the prescribed dioptric function Rx.

For example, the prescribed dioptric function Rx comprises a prescribed sphere SPH, optionally a prescribed astigmatism value CYL and a prescribed axis AXIS suitable for correcting the abnormal refraction of one eye, or both eyes of the wearer. The term “prescribed mean sphere” is defined as MeanSphere=SPH+CYL/2. For example, the first mean refractive power Pᵣ₁ is less than the prescribed mean sphere and the second mean refractive power Pᵣ₂ is greater than the prescribed mean sphere. Alternatively, the first mean refractive power Pᵣ₁ is greater than the prescribed mean sphere and the second mean refractive power Pᵣ₂ is less than the prescribed mean sphere. Examples of numerical values of the difference of the prescribed means sphere and Pᵣ₁ and of the difference of the prescribed mean sphere and Pᵣ₂ may be +/−2 diopters, +/−3.5 diopters, +/−4.5 diopters, +/−10 diopters or +/−20 diopters. The MeanSphere may be, for myopic people, comprised between 0 and −10 diopters.

The refractive microlenses may have a spherical shape. In another example, refractive microlenses may have an aspherical shape.

The refractive microlenses are spatially arranged on a squared array, one refractive microlens of the first subset of refractive microlenses alternating with one refractive microlens of the second subset of refractive microlenses. FIG. 4 illustrates such a configuration. In FIG. 4, it can be seen that concave refractive microlenses 41 alternate with convex refractive microlenses 42 arranged on a two-dimensional squared array. The convex refractive microlenses 42 have positive mean refractive power, while the concave refractive microlenses 41 have negative mean refractive power. In the arrangement of FIG. 4, the first mean refractive power and the second mean refractive power are equal to +3.5 diopters and −3.5 diopters. The distances dx and dy between the centers (or barycenters) of two neighbouring concave refractive microlenses 41 along the principal directions of the squared array are identical to those between two neighbouring convex refractive microlenses 42 and are equal to 1 mm for example.

FIG. 5 shows a comparison of different modulation transfer functions of the lens element 1 where the arrangement of microoptical elements 2 comprises an alternation of refractive microlenses of mean refractive power respectively +3.5 diopters and −3.5 diopters arranged on a squared array. As previously explained, the modulation transfer function (MTF) is defined as the response of an optical system, in terms of contrast, to a periodic sine-wave pattern passing through this optical system, as a function of its spatial frequency.

In the different arrangements of refractive microlenses of FIG. 5, the distance between the centers of two neighbouring refractive microlenses is 1 mm and the prescribed dioptric function Rx is null. The different curves correspond to different values of the diameters of the refractive microlenses: 1 mm (with void circles), 0.9 mm (with horizontal lines), 0.8 mm (with crosses), 0.75 mm (with black squared), 0.7 mm (with black triangles), 0.6 mm (with black disks). It can be observed that the smaller the diameter, the higher the modulation transfer function values over a large range of spatial frequencies, and thus the sharper the far vision. For instance, for refractive microlenses of diameter 0.6 mm, the modulation transfer function value of the lens element 1 is about 0.3 at a spatial frequency of 70 cycles per degree. This means that while wearing the lens element 1 with an arrangement of refractive microlenses of diameter 0.6 mm, the wearer can see higher resolution details than if the diameter of the refractive microlenses is higher than 0.6 mm. As a reference, for ophthalmic applications, it is relevant to consider the MTF up to spatial frequencies of about 50 cycles per degree.

In a second example, the prescribed dioptric function Rx is null and the refractive microlenses are contiguous. Therefore, the first mean refractive power Pᵣ₁ is negative and the second mean refractive power Pᵣ₂ is positive, or vice versa.

FIG. 6 illustrates this second example. FIG. 6A shows a top view of a portion of an arrangement of refractive microlenses, where the black disks represent concave microlenses 62 and the light disks represent convex microlenses 61, The free spaces areas between two neighbouring microlenses are areas presenting the curvature of either the front surface F1 or the rear surface F2. The distances px and py between the centers of two neighbouring convex refractive microlenses 61 along the principal directions of the squared array are identical to those between the centers of two neighbouring concave refractive microlenses 62 and are equal to 1 mm, or 1.4 mm for example. FIG. 6B represents the profile of the height of the arrangement of the microoptical elements along the dotted line of FIG. 6A. The mean height h₁ of the convex microlenses is about 1.2 microns and the mean height h₂ of the concave microlenses is about 1.8 microns. In this example, the values of the powers Pᵣ₁ and Pᵣ₂ are +3 diopters and −4.5 diopters.

FIG. 7 is another illustration of this second example. FIG. 7A shows a top view of a portion of an arrangement of refractive microlenses, where the black disks represent concave microlenses 72 and the light disks represent convex microlenses 71, In this case, there is no free spaces areas 73 between two neighbouring microlenses. FIG. 7B represents the profile of the height of the arrangement of the microoptical elements along a horizontal section passing through the centers of the black and light circles of FIG. 7A. In this example, the profile of the refractive microlenses can be spherical, parabolic, or aspheric for instance. The mean height of the convex microlenses and of the concave microlenses is approximately the same and equal to 0.95 microns. The spacing between two neighbouring convex and concave microlenses sx or sy is around 1 mm. For example, the values of the powers Pᵣ₁ and Pᵣ₂ are +4 diopters and −4 diopters.

The absolute values of the difference between the MeanSphere and the first mean refractive power Pᵣ₁ and of the difference between the MeanSphere and the first mean refractive power Pᵣ₂ may be equal or different. When they are different, the volume of light V is shifted either forwards with respect to the retina or backwards with respect to the retina. This allows designing the volume of light V, thus the induced blur, at wish.

FIG. 8 is a comparison of different modulation transfer functions of the lens element 1 where the arrangement of microoptical elements 2 comprises an alternation of refractive microlenses of mean refractive power respectively +3.5 diopters and −3.5 diopters arranged contiguously on a squared array.

The prescribed dioptric function Rx is null. The different curves correspond to different values of the distance sx or sy parallel to respectively the x-direction or the y-direction between the centers of two neighbouring refractive microlenses (concave 72 and convex 71), respectively 1 mm (with empty circles), 0.6 mm (with crosses), 0.5 mm (with black squares), 0.4 mm (with black triangles), 0.3 mm (with black disks). It can be observed that the smaller the diameter, the higher the modulation transfer function values. This means that, when wearing the lens element 1 with a squared array of contiguous refractive microlenses, the wearer sees higher resolution details when the diameter of the refractive microlenses is small, such as 0.3 mm, as for larger values of diameters.

In this second example where the refractive microlenses are contiguous, height discontinuities might occur. A way to improve this aspect is to add an offset. More precisely, in order to avoid the height discontinuities, each refractive microlens can be shifted along its normal direction.

FIG. 9 shows the comparison of modulation transfer functions of several squared arrays of contiguous refractive microlenses of distance between the centers of two neighbouring refractive lenses of respectively 0.5 mm and 0.4 mm with and without the addition of an offset. It can be observed that the addition of an offset increases the modulation transfer function values for all considered spatial frequencies up to 80 cycles per degree for a given distance between two neighbouring refractive microlenses as compared to no offset, thus improves the normal far vision.

In any case, in this first embodiment, when worn by the wearer, the lens element 1 creates a volume of light encompassing part of the retina. This volume of light induces blur on the scene observed by the wearer.

FIG. 10 represents another example where the refractive microlenses are contiguous and present an aspherical shape. FIG. 10 A represent a 3D view in gray levels of a portion of the arrangement of refractive microlenses. FIG. 10B represents the height profile in the vertical cross section plane represented on FIG. 10A. In this example the distance between the center of a convex microlens and the center of one of its neighbouring concave microlenses is approximately 0.70 mm. The height h₃ of the convex microlenses is 6 microns and the height h₄ of the concave microlens is 0.85 microns.

In a second embodiment, the arrangement of microoptical elements 2 comprises at least one bifocal refractive microlens.

Each bifocal refractive microlens presents a first refractive power P_{br1} producing the at least one first secondary luminous intensity maximum I₂₁ when illuminated by a collimated beam of monochromatic light, and a second refractive power P_{br2} producing the at least one second secondary luminous intensity maximum I₂₂ when illuminated by a collimated beam of monochromatic light. The first refractive power P_{br1} may be less than the prescribed mean sphere and the second refractive power P_{br2} may be greater than the prescribed mean sphere. Alternatively, the first refractive power P_{br1} is greater than the prescribed mean sphere and the second refractive power Pᵣ₂ is less than the prescribed mean sphere.

The at least one bifocal refractive lens might comprise a spatial mixture of bifocal refractive lenses of different kind. For instance, the spatial mixture comprises refractive microlenses with flat top and refractive microlenses with negative curvature on the top. In another example, the spatial mixture comprises refractive microlenses with positive curvature on the top and refractive microlenses with negative curvature on the top. For instance, the first refractive power P_{br1} may be higher by 4 diopters than the prescribed mean sphere and the second refractive power Pᵣ₂ may be less by 4 diopters than the prescribed mean sphere.

Therefore, when worn by the wearer, the lens element 1 creates a volume of light encompassing part of the retina. This volume of light induces blur on the scene observed by the wearer.

The absolute values of the difference between the MeanSphere and the first refractive power P_{br1} and of the difference between the MeanSphere and the second refractive power P_{br2} may be equal or different. When they are different, the volume of light V is shifted either forwards with respect to the retina or backwards with respect to the retina.

For instance, each bifocal refractive microlens presents a first portion consisting of a central circular zone 111 and a second portion consisting of a peripheral annular zone 112. The first portion and the second portion are either both convex or both concave. Alternately, the first portion could be convex and the second portion concave, or reversely. The section profile of the peripheral annular zone may be of any type, for instance spherical or aspherical. For instance, the first portion creates the first refractive power P_{br1}, and the second portion creates the second refractive power P_{br2}. FIG. 11 gives an example of the geometry of such a bifocal refractive microlens with the first portions 111 and the second portions 112.

When the at least one bifocal refractive microlens comprises at least two bifocal refractive microlenses of first refractive powers P_{br11}, respectively P_{br12}, and of second refractive power P_{br21}, respectively P_{br22}, the first refractive powers P_{br11} and P_{br12} may be different, as well as the second refractive powers P_{br21} and P_{br22}.

In this second embodiment, the prescribed dioptric function Rx is provided by the shapes of the front face F1 and of the rear face F2. For instance, the first refractive powers could be +4 diopters, at the center, and the second refractive powers could be −4 diopters, at the periphery. For instance, the radius of curvature of the central zone could be comprised between 0.5 mm and 1.5 mm and the total diameter of the bifocal microlens could be comprised between 1 and 3 mm.

In a third embodiment, at least part of the arrangement of microoptical elements are bifocal refractive microlenses. The prescribed dioptric function Rx is provided by the bifocal refractive microlenses. The arrangement of microoptical elements 2 comprises a first subgroup of the bifocal refractive microlenses presenting a prescription refractive power Pₚ configured to produce the primary luminous intensity maximum I₁ when illuminated by a collimated beam of monochromatic light, and a refractive power Pᵣₐ configured to produce the at least one first secondary luminous intensity maximum I₂₁ when illuminated by a collimated beam of monochromatic light. The arrangement of microoptical elements 2 further comprises a second subgroup of the bifocal refractive microlenses presenting the prescription refractive power Pₚ and another refractive power P_{rb} configured to produce the at least one second secondary luminous intensity maximum I₂₂ when illuminated by a collimated beam of monochromatic light.

In other words, the prescription refractive power Pₚ provides the prescribed dioptric function Rx. Besides, the first subgroup of the bifocal refractive microlenses provides a part of the volume of light V on one side of the prescription plane P and the second subgroup of the bifocal refractive microlenses provides with a part of the volume of light V on the other side of the prescription plane P. For instance, the prescription refractive power Pₚ could be comprised between 0 and −10 diopters, while the other refractive power P_{rb} could be bigger or lower than Pₚ (for instance, the absolute value of their difference could be 4 diopters).

The at least one bifocal refractive lens comprises a spatial mixture of bifocal refractive lenses of different kind. For instance, the spatial mixture comprises refractive microlenses with flat top and refractive microlenses with negative curvature on the top. In another example, the spatial mixture comprises refractive microlenses with positive curvature on the top and refractive microlenses with negative curvature on the top. For instance, the refractive power Pᵣₐ may be higher by 4 diopters than the prescription refractive power Pₚ and the other refractive power P_{rb} may be less by 4 diopters than the prescription refractive power Pₚ.

Therefore, when worn by the wearer, the lens element 1 creates a volume of light encompassing part of the retina. This volume of light induces blur on the scene observed by the wearer.

In a fourth embodiment, at least part of the arrangement of microoptical elements 2 are diffractive optical elements. For instance, diffractive optical elements may be Fresnel microlenses. In another example, the diffractive optical elements may be Pi-Fresnel microlenses. In another example, the diffractive optical elements may be multi-level microlenses.

The diffractive optical elements have been designed to work at the wavelength λ₀ of the collimated beam of monochromatic light used, if case may be, to illuminate the lens element 1.

In this fourth embodiment, when the lens element 1 receives the collimated beam of monochromatic light λ₀, the diffraction order +1 and the diffraction order −1 of the diffractive optical elements produce respectively the at least one first secondary luminous intensity maximum I₂₁, and the at least one second secondary luminous intensity maximum I₂₂, or vice versa. The prescribed dioptric function Rx is provided by the shapes of the front face F1 and of the rear face F2. The size of the diffractive optical elements could be comprised between 1 and 2 mm. The optical power for the diffraction order +1 could be +4 diopters and the optical power for the diffraction order −1 could be −4 diopters.

For instance, in case the diffractive optical elements are 4-level lenslets, the diameter of the elements could be 2 mm. The power in the diffraction order +1 would be +3.5 diopter. The diffractive optical elements are arranged on a squared pattern with contiguous elements separated by 2 mm.

In another example, the diffractive optical elements are Pi-Fresnel lenslets of diameter 2 mm. The power of the diffraction orders +1 and −1 is +3.5 diopters and −3.5 diopters. The diffractive optical elements are arranged on a squared pattern contiguously and separated by 2 mm.

In a fifth embodiment, at least part of the arrangement of microoptical elements 2 are diffractive optical elements. The prescribed dioptric function Rx is provided by the diffractive optical elements.

In a first example, the arrangement of microoptical elements 2 comprises a first subset of the diffractive optical elements presenting at least a prescription diffraction order for the wavelength λ₀. The prescription diffraction order produces the primary luminous intensity maximum I₁. The first subset of the diffractive optical elements further presents a diffraction order for the wavelength λ₀ which produces the at least one first secondary luminous intensity maximum I₂₁. Therefore, in this first example, the first subset of diffractive optical elements creates a volume of light V located on one side of the prescription plane P when the lens element 1 receives the collimated beam of monochromatic light λ₀. The diffractive optical elements could be Pi-Fresnel lenslets and their diameters could be comprised between 1 and 2 mm. The optical power, for instance, is 0 diopter for the diffraction order 0 and +4 diopters for the diffraction order 1.

In another example, the diffractive optical elements could be 4-level lenslets with maximum phase of Pi of diameter 2 mm. The optical power would be +3.5 diopters for the first subset of diffractive optical elements. For instance, the 4-level lenslets can be arranged on a squared pattern, separated by a distance of 4 mm.

Therefore, when worn by the wearer, the lens element 1 creates a volume of light intercepted by the retina, forming an extended spot on the retina. This extended spot induces blur on the scene observed by the wearer.

In a second example, the arrangement of microoptical elements 2 comprises a second subset of diffractive optical elements presenting at least the prescription diffraction order of the first example and another diffraction order for the wavelength λ₀ which produces the at least one second secondary luminous intensity maximum I₂₂. Therefore, in this second example, the second subset of diffractive optical elements creates a volume of light V located on the other side of the prescription plane P, as compared to the first example, when the lens element 1 receives the collimated beam of monochromatic light λ₀.

Therefore, when worn by the wearer, the lens element 1 creates a volume of light intercepted by the retina, forming an extended spot on the retina. This extended spot induces blur on the scene observed by the wearer.

Alternatively, the lens element 1 results from the combination of the diffractive optical elements according to the first example and to the second example. In that case, the combination of the first subset of the diffractive optical elements and of the second subset of the diffractive optical elements creates a volume of light V extending on both sides of the prescription plane. Therefore, when worn by the wearer, the lens element 1 creates a volume of light encompassing part of the retina. This volume of light induces blur on the scene observed by the wearer.

FIG. 12 shows an example of arrangement according to the fifth embodiment, where the diffractive optical elements are Pi-Fresnel microlenses 121 arranged on a hexagonal array. The diameter of the Pi-Fresnel microlenses 121 is 1 mm. The optical power for the order 0 is 0 diopter and for the order +1, +20 diopters.

FIG. 13 shows different diffraction orders of a binary diffractive optical element 13, which we recall is a special type of multi-level diffractive optical element, presenting a two-level surface height. Parts 131 and 132 show the two different height levels of the binary diffractive optical element 13. The diffraction orders 0, 1, and −1 are each indicated by a different line representing each the diffraction direction of the red wavelength, the green wavelength and the blue wavelength, respectively.

In a sixth embodiment, at least part of the arrangement of microoptical elements are holographic micromirrors. The holographic micromirrors have been recorded with monochromatic light of bandwidth less than 1 nm (typically less than 5 MHz). Advantageously, the efficient width of the spectrum centered at the wavelength λ₀ of the holographic micromirrors is determined by the material of the holographic mirrors and the recording parameters. The efficient width of the spectrum is typically comprised between 5 and 20 nm, and preferentially less than 10 nm to avoid disturbing the vision of colors for the wearer.

In a first example, the lens element 1 is integrated into a frame 143 as illustrated on FIG. 14. The frame is positioned in front of the wearer's eyes 141. An external light source 144 is embedded within the frame 143, for instance located and fixed on one temple of the frame 143. The holographic micromirrors 142 reflect the light coming from the external light source 144 into the eye of the wearer. Advantageously, the external light source 144 presents a monochromatic wavelength sensibly equal to the wavelength of the monochromatic light λ₀ used for recording the interference pattern producing the micromirrors.

In this example, a first subset of the holographic micromirrors 142 has a first mean optical power producing the at least one first secondary luminous intensity maximum I₂₁ when the external light source 144 is switched on. A second subset of the holographic micromirrors 142 has a second mean optical power producing the at least one second secondary luminous intensity maximum I₂₂ when the external light source 144 is switched on. For instance, the first mean optical power is less than the MeanSphere and the second mean optical power is stronger than the MeanSphere, or vice versa. In this example, the holographic micromirrors are positioned in a random fashion on the lens element 1.

Therefore, when worn by the wearer, the lens element 1 creates a volume of light encompassing part of the retina. This volume of light induces blur on the scene observed by the wearer.

In a second example, no external source is embedded within the frame 143. The micromirrors 142 reflect the natural light received by the wearer through the edges of the frame of the lens element 1. The first subset of the holographic micromirrors produces the at least one first secondary luminous intensity maximum I₂₁. The second subset of the holographic micromirrors produces the at least one second secondary luminous intensity maximum I₂₂.

In another embodiment, the microoptical elements 2 are coated.

The different embodiments described above may be combined. As a consequence, the lens element 1 according to the invention may comprise an arrangement of microoptical elements 2 that are different in nature, structure and/or dimensions.

In a variant, in each of the embodiments described above, diffusing elements are used in addition to the arrangement of microoptical elements so as to further design the volume of light V.

In another variant, an alternation of positive and negative refractive microlenses are fabricated by adding a hard coating on an array of microlenses. For instance, an array of microlenses according to FIG. 10 might be used. The refraction index of the hard coating is lower than the refractive index of the microlenses. Such a hard coated array of microlenses may produce the same effect as an uncoated array of microlenses, provided some conditions on the refractive indices and the dimensions of the microlenses. The hard coating should be flat or be parallel to the base curve. For instance, with respect to an uncoated array of microlenses in polycarbonate of refractive index 1.59, a hard coated array of microlenses for which the difference between the refractive indices of the microlenses and of the hard coating is 0.1 would require the height of the microlenses to be 6 times higher, as well as their curvatures. FIG. 15 illustrates a cross section of such an alternation of convex refractive microlenses 151 and of concave refractive microlenses 152 on which a hard coating 153 has been deposited.

Advantages of the invention reside in the fact that by controlling the size, the dioptric power or locations of diffraction orders, the geometrical arrangement such as the type of arrangement, the spacing between neighbouring microoptical elements, the filling ratio of the microoptical elements, the blur induced by this arrangement of microoptical elements may be controlled in an easy manner. In other words, the induced blur may be specifically oriented with respect to the retina as wished, for instance a bigger portion in front of the retina, or behind the retina, or a balance.

Also, micro-optical elements present an aesthetic advantage as compared to prior art solutions.

1. A lens element intended to be worn in front of an eye of a wearer, the lens element being adapted to provide a prescribed dioptric correction function in a predetermined plane, the lens element comprising an arrangement of microoptical elements, wherein, when receiving a collimated beam of monochromatic light:
the lens element is configured to produce a primary luminous intensity maximum in a predetermined plane, and
the arrangement of microoptical elements covering a whole surface of the lens element or at least a part of the surface of the lens element, the arrangement of microoptical elements is configured to produce at least one first secondary luminous intensity maximum at a first proximity difference from the predetermined plane and at least one second secondary luminous intensity maximum at a second proximity difference from the predetermined plane, the first proximity difference and the second proximity difference having opposite signs, wherein the microoptical elements comprise holographic micromirrors, wherein a first subset of the holographic micromirrors has a first mean optical power configured to produce the at least one first secondary luminous intensity maximum, and wherein a second subset of the holographic micromirrors has a second mean optical power configured to produce the at least one second secondary luminous intensity maximum.

2. The lens element according to claim 1, wherein the microoptical elements have a size each of less than 2 mm.

3. The lens element according to claim 1, comprising a front face and a rear face adapted to provide the prescribed dioptric correction function.

4. The lens element according to claim 1, wherein the arrangement of microoptical elements comprises a structured array selected among a squared array, a hexagonal array, or a combined octagonal squared array.

5. The lens element according to claim 1, wherein the arrangement of microoptical elements comprises a random spatial arrangement.

6. The lens element according to claim 1, wherein the microoptical elements further comprise spatially alternated refractive microlenses, wherein a first subset of the refractive microlenses has a first mean refractive power configured to produce the at least one first secondary luminous intensity maximum, and
wherein a second subset of the refractive microlenses has a second mean refractive power configured to produce the at least one second secondary luminous intensity maximum.

7. The lens element according to claim 1, wherein the microoptical elements further comprise at least one bifocal refractive microlens presenting a first refractive power configured to produce the at least one first secondary luminous intensity maximum, and a second refractive power configured to produce the at least one second secondary luminous intensity maximum.

8. The lens element according to claim 1, wherein the microoptical elements further comprise bifocal refractive microlenses, wherein a first subgroup of the bifocal refractive microlenses presents a predetermined refractive power configured to produce the primary luminous intensity maximum and a refractive power configured to produce the at least one first secondary luminous intensity maximum, and
wherein a second subgroup of the bifocal refractive microlenses presents the predetermined refractive power and another refractive power configured to produce the at least one second secondary luminous intensity maximum.

9. The lens element according to claim 1, wherein the microoptical elements further comprise diffractive optical elements presenting at least a first diffraction order for said monochromatic light configured to produce the at least one first secondary luminous intensity maximum, and a second diffraction order for said monochromatic light configured to produce the at least one second secondary luminous intensity maximum.

10. The lens element according to claim 1, wherein the microoptical elements further comprise diffractive optical elements, wherein a first subset of the diffractive optical elements presents at least a predetermined diffraction order for said monochromatic light configured to produce the primary luminous intensity maximum and a diffraction order for said monochromatic light configured to produce the at least one first secondary luminous intensity maximum, and/or wherein a second subset of diffractive optical elements presents at least the predetermined diffraction order and another diffraction order for said monochromatic light configured to produce the at least one second secondary luminous intensity maximum.

11. The lens element according to claim 9, wherein the diffractive optical elements comprise Fresnel microlenses or multi-level microlenses.

12. The lens element according to claim 1, wherein the microoptical elements are located on one of the two faces or between the two faces.

13. The lens element according to claim 1, wherein the first proximity difference and the second proximity difference are higher than 0.5 diopter in absolute value.

14. A method for manufacturing a lens element according to claim 1, wherein the microoptical elements are formed by photolithography, holography, molding, machining or encapsulation.

15. The lens element according to claim 2, comprising a front face and a rear face adapted to provide the prescribed dioptric correction function.

16. The lens element according to claim 2, wherein the arrangement of microoptical elements comprises a structured array selected among a squared array, a hexagonal array, or a combined octagonal squared array.

17. The lens element according to claim 3, wherein the arrangement of microoptical elements comprises a structured array selected among a squared array, a hexagonal array, or a combined octagonal squared array.

18. The lens element according to claim 2, wherein the arrangement of microoptical elements comprises a random spatial arrangement.

19. The lens element according to claim 3, wherein the arrangement of microoptical elements comprises a random spatial arrangement.

20. The lens element according to claim 4, wherein the arrangement of microoptical elements comprises a random spatial arrangement.
